(19) United States
(12) Patent Application Publication
(10) Pub. No.: US 2022/0228846 A1
(43) Pub. Date: Jul. 21, 2022

(54) METHOD FOR PRODUCING A DEVICE FOR MEASURING DEFORMATIONS ON A CERAMIC MATRIX COMPOSITE PART, AND CORRESPONDING PART

(71) Applicant: SAFRAN AIRCRAFT ENGINES, Paris (FR)

(72) Inventors: Lucien Henri Jacques QUENNEHEN, MOISSY-CRAMAYEL (FR); Christophe TOUCHON, MOISSY-CRAMAYEL (FR)

(73) Assignee: SAFRAN AIRCRAFT ENGINES, Paris (FR)

(21) Appl. No.: 17/608,286

(22) PCT Filed: May 7, 2020
(86) PCT No.: PCT/EP2020/062721

§ 371 Date: Nov. 2, 2021

(30) Foreign Application Priority Data
May 9, 2019 (FR) FR1904809

(51) Int. Cl. G01B 1/00; G01B 7/16; G01L 1/22

(52) U.S. Cl. CPC G01B 1/00; F01D 21/003; G01L 1/2287; G01B 7/20

(57) ABSTRACT

The invention relates to a method for producing a device lot measuring deformations on a ceramic matrix composite part, and to the corresponding part. Said method for producing a device (3) for measuring deformations on a ceramic matrix composite part (1), in particular an aeronautical part, according to which an electrically insulating coating (2) is first formed on the part (1) and a deformation gauge (3) is subsequently placed on the coating (2), is in particular characterised in that the coating (2) comprises a rare earth oxide.

### FIELD OF THE INVENTION

The present invention is in the field of the production of a device for measuring deformations on a ceramic matrix composite part.

### RELATED ART

In the aeronautical field, it is becoming more and more common, in particular for the manufacture of turbine parts, to use a ceramic matrix composite (CMC) instead of a metallic material.

The expression “ceramic matrix composite” is understood to mean a composite consisting of carbon and/or silicon carbide fibers, and sometimes mullite (3Al₂O₃, 2SiO₂), embedded in a matrix made of the same type of compounds. This CMC can consist exclusively of SiC fibers, embedded in a matrix of the same nature.

The use of such a material is explained in particular by their high resistance to high temperature.

It is of course necessary to instrument such parts, i.e., to equip them with deformation measuring devices (in other words gauges) in order to be able to analyze the stresses to which these parts are subjected, during tests.

However, the technologies developed on current aeronautical parts need to be improved, for several reasons.

For the installation of gauges, it is common to use an alumina sublayer for metallic parts to receive the gauge in order to promote a good adhesion of the gauge on the aeronautical part and, consequently, to guarantee a good quality of measurement of the gauge.

However, if the aeronautical part and the sublayer have coefficients of expansion that are too different, this amounts to measuring the stresses in the sublayer and not really those in the aeronautical part.

Moreover, there is a risk of generating too high stresses at the metal/sublayer interface and, consequently, of detaching the gauge.

As far as CMC aeronautical parts are concerned, they are subjected to temperatures greater than 1300° C., which requires the use of materials that are also capable of withstanding these temperatures.

Moreover, CMC expands less than metal, so that the gauge bonding methods used to date are not directly applicable.

Finally, CMC is a conductive material. Since the principle of operation of a gauge is its electrical resistance, it cannot be in direct contact with an electrically conductive material.

There is therefore a need to improve the measurement of deformations, in particular on CMC aeronautical parts via deformation measuring devices.

In the same sense, EP1990633 and FR2915493 describe processes for the production of a deformation measuring device as well as the corresponding measuring devices.

These known processes have in common the fact that they include a step of depositing an alumina coating on the CMC part, followed by the application of a deformation gauge on this coating.

Thus, the alumina coating acts as an electrical insulator between the CMC part and the gauge.

On the whole this technique is satisfactory. However, despite all the precautions taken, in some cases problems have been observed with the resistance of the coating and more particularly with delamination at the coating/CMC interface.

This phenomenon is probably due to a significant difference between the coefficients of expansion at high temperature of alumina on the one hand and of CMC on the other hand.

There is also a need to improve the known processes to improve the deformation measurements performed, in particular on CMC aeronautical parts via deformation measuring devices.

Furthermore, WO2018/127664 describes a part comprising a substrate with at least one portion of silicon-containing material adjacent to a substrate surface, and an environmental barrier formed on the substrate surface, comprising a rare-earth compound.

Thus, the aim of the present invention is to provide a solution to the needs expressed above.

### Presentation of the Invention

To this end, the invention relates to a process for producing a device for measuring deformations on a ceramic matrix composite part, in particular an aeronautical part, according to which an electrically insulating coating is first produced on said part, and then a deformation gauge is placed on said coating.

In accordance with the invention, said coating comprises a rare-earth oxide.

Thanks to the features of the invention, the gauge is observed to have an excellent resistance over time, without presenting the problems of delamination mentioned above.

Furthermore, the coating layer is made of a material (rare-earth oxide) that has a low differential expansion with respect to the ceramic matrix composite. Under these conditions, the measurement made by the gauge is therefore reliable because it is not disturbed by a differential expansion of the coating in relation to the ceramic matrix composite.

Finally, the coating material is insulating, so that the gauge is not disturbed by the conductive nature of the ceramic matrix composite.

According to other advantageous and non-limiting features of this process, taken alone or in combination:
said coating comprises a silicate;
said coating is produced by a plasma process;
said coating is produced by a sol-gel process;
said coating has a thickness comprised between a few hundredths of a millimeter and a few tenths of a millimeter;
prior to the step according to which an electrically insulating coating is placed on said part, a silicon sublayer is deposited on said part;
said gauge is placed on said part by photosensitization or by additive manufacturing;
after having placed said gauge on said coating, this gauge is covered with an additional coating comprising a rare-earth oxide.

The invention also relates to a ceramic matrix composite part, such as an aeronautical part, which carries at least one deformation measuring device obtained by implementing a process as presented above and which is characterized by the fact that it has on its surface a coating comprising a rare-earth oxide on which said deformation measuring device rests.

According to an embodiment, said coating comprises a silicate.

### DESCRIPTION OF THE FIGURES

Other features and advantages of the invention will emerge from the description that will now be given, with reference to the appended drawings, which represent, by way of non-limiting illustration, various possible embodiments.

In these drawings:

FIG. 1 is a diagram illustrating a first step of the process according to the invention;

FIG. 2 is a diagram illustrating another step of the process according to the invention;

FIG. 3 is an illustration of yet another step of the process according to the invention;

FIG. 4 is a simplified perspective view showing a deformation gauge, in place on a CMC part.

### DETAILED DESCRIPTION OF THE INVENTION

It should be recalled that deformation gauges are flat resistors that are placed on parts.

A first step of the process according to the invention consists in producing, on a CMC part, an electrically insulating rare-earth oxide coating.

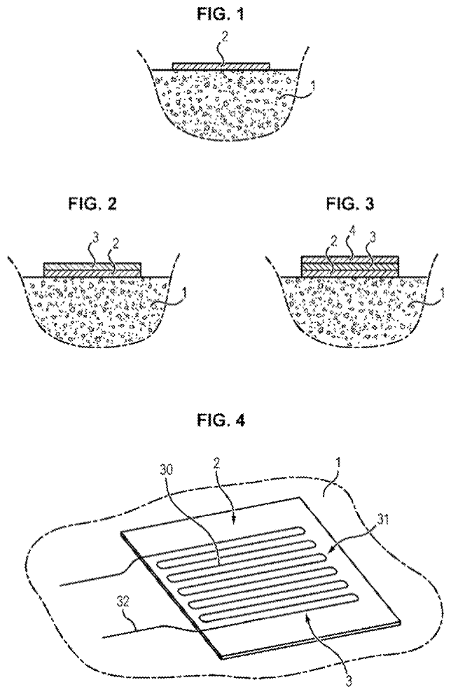

This step is shown schematically in the appended FIG. 1, in which reference 1 designates the CMC part to be treated, while reference 2 designates the rare-earth oxide coating.

In this figure in particular, but also in the other figures, the dimensions, thicknesses and shapes of the elements shown are for illustrative purposes only and do not correspond to reality.

The rare earths are the chemical elements with atomic numbers between 57 and 71, to which are added scandium, with atomic number 21 and yttrium, with atomic number 39.

The complete list of these rare earths is therefore as follows: lanthanum, cerium, praseodymium, neodymium, promethium, samarium, europium, gadolinium, terbium, dysprosium, holmium, erbium, thulium, ytterbium, lutetium, scandium and yttrium.

Advantageously, this rare-earth oxide is a silicate. Furthermore, it is possible to use a silicate of a single rare-earth, or of two different rare-earths, i.e., in which the silicon and oxygen atoms are combined with two different rare earths.

As mentioned above, CMC is electrically conductive. However, since the operating principle of a gauge is its electrical resistance, it should not be directly on the material conducting electricity.

Since rare-earth oxides are not electrically conductive, the gauge carried by the coating 2 is not disturbed by the conductive nature of the CMC.

Moreover, the rare-earth oxide that forms the coating can be deposited on the surface of the part 1 by techniques such as the “sol-gel” process or the “plasma” process.

The “sol-gel” process allows the deposition of very thin layers (i.e., of the order of a few hundredths of a millimeter) of rare-earth oxide, very thin layers which therefore do not affect or hardly affect the quality of the measurement made by the gauge. By using the “plasma” process, the deposit will be thicker (of the order of a few tenths of millimeters), so that machining will be necessary.

These techniques are known per se and do not form the core of the present invention.

It is therefore sufficient to recall that the “sol-gel” technology makes it possible to produce glassy materials, if need be porous, by sintering (and possible thermal reprocessing), without having to resort to the fusion of the material.

The temperature resistance of rare-earth oxides exceeds 1300° C., which is compatible with the temperatures to which the part 1 is subjected when it is an aeronautical part.

According to a particular embodiment, not shown in the appended figures, a silicon sublayer is deposited on the part 1, prior to the coating 2. This creates an additional and intercalated thickness, guaranteeing a better adhesion of the coating 2 on the part 1.

The subsequent step of the process consists in forming a deformation gauge 3 on said coating 2. This gauge, shown very symbolically in FIG. 2, is better seen in FIG. 4 even though, again, it is an illustrative representation.

It is a free-filament gauge 3. Such a gauge is known to the person skilled in the art, and only its general structure is recalled here. The gauge 3 comprises a filament 30 which is shaped like an accordion as follows: the filament is bent back on itself a first time to form a “U” having a given height, then it is bent back on itself a second time to form a second “U” located in the same plane as the first “U” and whose branches have the same height, but inverted.

The filament is thus bent back on itself many times in the same process, without the branches of the “U”s touching, so as to form a grid 31 in one plane.

The grid 31 has a generally rectangular shape, and is extended on one side by the two ends 32 of the filament, which respectively extend the first branch of the first “U” and the last branch of the last “U” of the grid 31. The ends 32 are substantially parallel and located in the same plane as the grid 31.

The ends 32 of the filament are connected to an electrical apparatus which passes a current through the filament, in order to measure in real time the variations of the electrical resistivity of the filament, and thus the deformations of the part on which it is fixed.

Of course, it is necessary to pay attention to the passage of the cables to connect the gauge 3 to the acquisition channel, i.e., to said electrical apparatus.

Advantageously, this gauge is made of silicon. The use of this material is particularly practical, since it has a melting temperature of greater than 1400° C., which is far enough from the maximum operating temperature of the parts. In addition, the CMC has its matrix partially made of silicon, which facilitates material sourcing.

In a possible embodiment, once the gauge is manufactured, it is covered with a new layer 4 of rare-earth oxide. In this way, the gauge is “encapsulated” between two thicknesses of rare-earth oxide, thus counteracting the possibility of the gauge becoming separated from its support. In a variant embodiment, this new layer 4 can be made of alumina.

The gauge can be manufactured in several ways. Among these, photosensitization and additive manufacturing are preferred.

Regarding photosensitization, doped silicon is first deposited on the coating. The pattern of the gauge is then projected for photo-printing. The areas not covered by the doped silicon are then masked and the doped silicon is etched. Only the gauge remains and the rest of the silicon is removed.

In additive manufacturing, the gauge can be printed by mesh using a laser (using the technique known as “Laser Metal Deposition”) or using an electric arc.

It should be noted that the use of additive manufacturing makes it possible to obtain a gauge with a reduced surface area compared with known gauges, hence a smaller footprint.

Among the CMC parts in the aeronautical sector that can be coated with such gauges, in accordance with the present invention, mention may be made, by way of example, of turbine rings and more particularly all the out-of-vein areas, turbine nozzles and more particularly the blades and platforms, engine nozzle flaps on the out-of-vein side, fuel injection tube cowlings, etc.

1. A process for producing a device for measuring deformations on a ceramic matrix composite part, in particular an aeronautical part, according to which an electrically insulating coating is first produced on said part, and then a deformation gauge is placed on said coating, wherein said coating comprises a rare-earth oxide.

2. The process as claimed in claim 1, wherein said coating comprises a silicate.

3. The process as claimed in claim 1, wherein said coating is produced by a plasma process.

4. The process as claimed in claim 1, wherein said coating is produced by a sol-gel process.

5. The process as claimed in claim 1, wherein said coating has a thickness comprised between a few hundredths of a millimeter and a few tenths of a millimeter.

6. The process as claimed in claim 1, wherein, prior to the step according to which an electrically insulating coating is placed on said part, a silicon sublayer is deposited on said part.

7. The process as claimed in claim 1, wherein that said gauge is placed on said part by photosensitization or by additive manufacturing.

8. The process as claimed in claim 1, wherein, after having placed said gauge on said coating, this gauge is covered with an additional coating comprising a rare-earth oxide.

9. An aeronautical ceramic matrix composite part which carries at least one deformation measuring device (3) obtained by the process as claimed in claim 1, wherein it comprises a measuring surface on which is produced a coating comprising a rare-earth oxide on which said deformation measuring device rests.

10. The part as claimed in claim 9, wherein said coating comprises a silicate.
